(19) United States
(12) Patent Application Publication
(10) Pub. No.: US 2013/0181795 A1
(43) Pub. Date: Jul. 18, 2013

(54) ELECTROMAGNETIC VALVE

(71) Applicant: DENSO CORPORATION, Kariya-city (JP)

(72) Inventors: Naoki MITSUMATA, Takahama-city (JP); Shigeru NONOYAMA, Miyoshi-city (JP)

(73) Assignee: DENSO CORPORATION, Kariya-city (JP)

(21) Appl. No.: 13/719,655

(22) Filed: Dec. 19, 2012

(30) Foreign Application Priority Data
Jan. 13, 2012 (JP) 2012-4786

(51) Int. Cl. H01F 7/08

(52) U.S. Cl. CPC H01F 7/081
USPC 335/281

(57) ABSTRACT

An electromagnetic valve includes a coil that generates a magnetic force, a stator core arranged radially inward of the coil, an armature moved toward the stator core in an axial direction of the coil by the magnetic force, a yoke arranged on radially outward of the coil, a housing axially contacting the yoke and including a slide hole supporting the armature slidably, and a ring-shaped magnetic plate. The ring-shaped magnetic plate faces to the armature on a radially inner side of the magnetic plate, and faces to the yoke via a clearance on a radially outer side of the magnetic plate. The magnetic plate radially contacts the housing on the one side in the axial direction with reference to a position where the yoke contacts the housing, and on a radially outer side of an inner surface of the slide hole.

### CROSS REFERENCE TO RELATED APPLICATION

This application is based on and incorporates herein by reference Japanese Patent Application No. 2012-004786 filed on Jan. 13, 2012.

### TECHNICAL FIELD

The present disclosure relates to an electromagnetic valve including an armature that is movable by a magnetic attraction force.

### BACKGROUND

Conventionally, an electromagnetic valve is used as a decompression valve that discharges and decompresses high-pressure fuel stored in a common rail as shown in FIGS. 4A and 4B (e.g., Patent Document 1: JP 2011-202770 A). An electromagnetic valve 100 shown in FIGS. 4A and 4B includes a housing 101, a rod 102 supported slidably in its axial direction in the housing 101, and an electromagnetic actuator 105 that actuates the rod 102. A valve body is provided at a tip of the rod 102, and the valve body opens or closes a valve hole provided in the housing 101 by moving depending on motion of the rod 102. The electromagnetic actuator 105 includes a cylindrical coil 107 which generates a magnetic field upon energization thereof, a stator core 108 arranged radially inward of the coil 107 to be magnetized upon the energization of the coil 107, a yoke 109 arranged radially outward of the coil 107 to constitute a magnetic path together with the stator core 108, and an armature 110 attracted toward the stator core 108. An end surface 101a of the housing 101 in the axial direction contacts the yoke 109 and a magnetic plate 112. The magnetic plate 112 is used as a part of the magnetic path provided between the armature 110 and the yoke 109. A radially inner surface of the magnetic plate 112 faces to a radially outer surface of the armature 110, and a radially outer surface of the magnetic plate 112 faces to the yoke 109. A collar 113, which is non-magnetic, is interposed between the magnetic plate 112 and the stator core 108.

The electromagnetic valve 100 includes a subassembly referred to as a first assembly 117, and another subassembly referred to as a second assembly 118. The first assembly 117 includes the stator core 108, the magnetic plate 112, the collar 113, the housing 101, the armature 110 and the rod 102. In the first assembly 117, the stator core 108, the magnetic plate 112, the collar 113 and the housing 101 are integrated by welding or the like, and the armature 110 and the rod 102 are accommodated therein. The second assembly 118 includes the coil 107, the yoke 109 and a connector 115. The electromagnetic valve 100 is assembled by following steps: (i) the second assembly 118 is attached to the first assembly 117 such that the stator core 108 is inserted into the coil 107, (ii) the connector 115 is set at a predetermined position by rotating the second assembly 118, and (iii) the first assembly 117 is fastened to the second assembly 118 by using a nut 120.

For the purpose of the rotation of the second assembly 118 with respect to the fist assembly 117, small clearances C are provided between a radially inner surface of the coil 107 and a radially outer surface of the stator core 108, and between the yoke 109 and a radially outer surface of the magnetic plate 112.

Because the clearance C between the yoke 109 and the radially outer surface of the magnetic plate 112 is an air space, a magnetic flux is difficult to pass through the clearance C. Thus, the magnetic flux passes through the housing 101 that contacts both the yoke 109 and the magnetic plate 112. Accordingly, a closed magnetic path is provided upon the energization of the coil 107, and the closed magnetic path passes through the stator core 108, the armature 110, the magnetic plate 112, the housing 101, the yoke 109 and the nut 120 as shown by an alternate long and short dash line in FIG. 4B.

When the housing 101 is made of a magnetic material, a magnetic flux density can be kept high in the closed magnetic path. Alternatively, the housing 101 may be made of hardened steel in terms of securement of mechanical strength. When the housing 101 is made of a non-magnetic material such as the hardened steel (e.g., SCM415 (chromium molybdenum steel)), the magnetic flux density in the housing 101 may decrease. As a result, a magnetic attraction force generated upon the energization of the coil 107 may decrease.

It is an objective of the present disclosure to provide an electromagnetic valve, in which reduction of a magnetic attraction force is limited while mechanical strength of a housing is ensured.

### SUMMARY

According to an aspect of the present disclosure, an electromagnetic valve includes a coil, a stator core, an armature, a yoke, a housing and a ring-shaped magnetic plate. The coil generates a magnetic force when being energized, and the stator core is arranged on a radially inner side of the coil to serve as a magnetic path. The armature is arranged on one side in an axial direction of the coil with reference to the stator core to be movable toward the stator core by the magnetic force. The yoke is arranged on a radially outer side of the coil to serve as a magnetic path. The housing is arranged on the one side in the axial direction with reference to the yoke to serve as a magnetic path and to axially contact the yoke. The housing includes a slide hole supporting the armature slidably. The magnetic plate faces to an outer peripheral surface of the armature on a radially inner side of the magnetic plate, and the magnetic plate faces to the yoke via a clearance on a radially outer side of the magnetic plate.

The magnetic plate radially contacts the housing on the one side in the axial direction with reference to a position where the yoke contacts the housing, and on a radially outer side of an inner surface of the slide hole.

Accordingly, when a closed magnetic path passing through the stator core, the armature, the magnetic plate, the housing and the yoke is generated upon the energization of the coil, a distance traveled by a magnetic flux in the housing can be shortened. Therefore, even when the housing is made of a non-magnetic material superior in mechanical strength, a decrease in a magnetic attraction force can be limited.

The housing may include a large hole provided on the other side in the axial direction with reference to the slide hole to communicate with the slide hole. The large hole may be radially larger than the slide hole. The magnetic plate may include an axially one-side portion on the one side in the axial direction, and the axially one-side portion may be inserted into the large hole to be fixed to the housing. This is an example of a fixed state of the magnetic plate.

The slide hole and the large hole may be arranged to provide a step portion between the large hole and the slide hole, and the magnetic plate may have a surface contacting the step portion on the one side in the axial direction with reference to the magnetic plate. In this case, a position of the magnetic plate in the axial direction can be determined easily.

The magnetic plate may be fixed to the housing by press-fitting, welding, crimping or brazing. These are examples of a fixed state between the magnetic plate and the housing. Alternatively, the magnetic plate may be fixed to the housing by adopting one of the fixing methods: welding, crimping and brazing, in addition to press-fitting. Accordingly, the magnetic plate can be fixed to the housing more tightly.

According to another aspect of the present disclosure, an electromagnetic valve includes a coil, a stator core, an armature, a yoke, a cylindrical housing and a ring-shaped magnetic plate. The coil generates a magnetic force when being energized, and the stator core is arranged on a radially inner side of the coil. The armature is arranged on one side in an axial direction of the coil with reference to the stator core to be movable toward the stator core by the magnetic force. The yoke is arranged on a radially outer side of the coil, and the yoke has a cylindrical shape covering the coil from radially outside. The housing is arranged on the one side in the axial direction with reference to the yoke, and the housing has a first contact surface that axially contacts the yoke. The first contact surface is located on the one side in the axial direction with reference to the coil. The magnetic plate is located on a radially inner side of the yoke and the housing. The magnetic plate faces to the armature on a radially inner side of the magnetic plate, and faces to the yoke via a clearance on a radially outer side of the magnetic plate. The housing further has a second contact surface that radially contacts the magnetic plate on a radially inner side of the housing.

### BRIEF DESCRIPTION OF THE DRAWINGS

The disclosure, together with additional objectives, features and advantages thereof, will be best understood from the following description, the appended claims and the accompanying drawings, in which:

FIG. 1 is a sectional view showing a decompression valve according to an exemplar embodiment;

FIG. 2A is a sectional view showing a part of the decompression valve, corresponding to the part II shown in FIG. 1;

FIG. 2B is a sectional view showing a part of a decompression valve according to a comparative example;

FIG. 3 is a diagram showing a relationship between a distance T of a clearance C and a magnetic attraction force generated upon energization of a coil;

FIG. 4A is a sectional view showing a decompression valve according to a related art; and

FIG. 4B is a sectional view showing a part of the decompression valve, corresponding to the part IVB in FIG. 4A.

### DETAILED DESCRIPTION

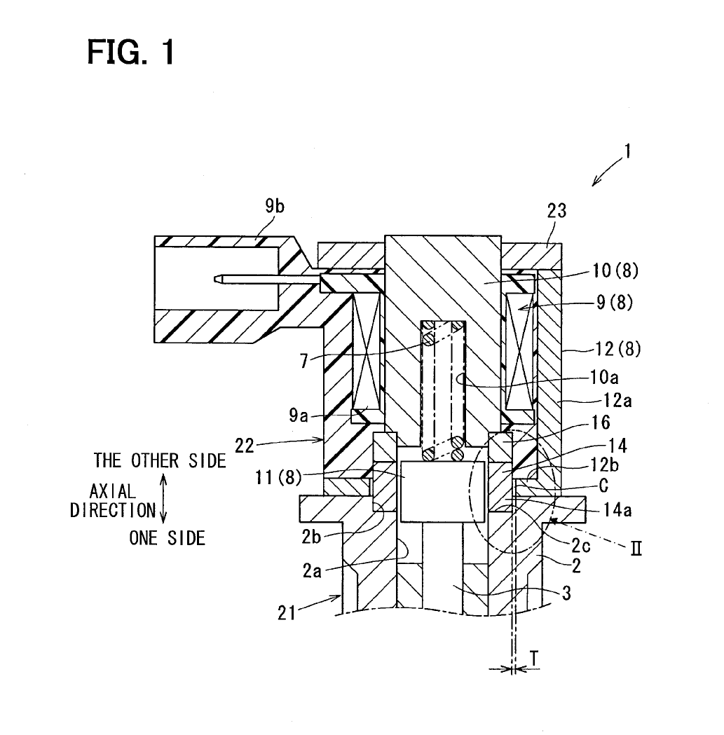

An electromagnetic valve according to an exemplar embodiment of the present disclosure will be described hereinafter referring to FIGS. 1 to 3. The electromagnetic valve of the present embodiment is used as a decompression valve 1 for reducing a pressure in a common rail that accumulates fuel therein at high pressure.

The decompression valve 1 includes a housing 2, a rod 3 that slides in an axial direction thereof in the housing 2, a valve body (not shown) provided at a tip portion of the rod 3, and a drive portion that drives the rod 3. As shown by the two-ended arrows in drawings, a lower side in each drawing is referred to as one side in the axial direction, and an upper side in each drawing is referred to as the other side in the axial direction.

The drive portion drives the valve body via the rod 3, and the drive portion includes a spring 7 and an electromagnetic actuator 8. The electromagnetic actuator 8 includes a cylindrical coil 9 which generates a magnetic attraction force upon energization thereof, a stator core 10 arranged on a radially inner side of the coil 9 to serve as a magnetic path, an armature 11 arranged on the one side in the axial direction with reference to the stator core 10 to be opposed to the stator core 10 and to be moved toward the stator core 10 by the magnetic attraction force, and a yoke 12 arranged on a radially outer side of the coil 9 to serve as a magnetic path. The coil 9 is coaxial with the rod 3.

The coil 9 includes a coil body 9a and a connector 9b through which the coil body 9a is connected to an outside portion. The connector 9b is, for example, formed of a part of a resin material that is molded to cover the coil body 9a, and the connector 9b protrudes radially outward from the coil body 9a.

The stator core 10 is made of a magnetic material (e.g., ferromagnetic material such as iron), and has a bottomed cylindrical shape. The stator core 10 has a spring housing hole 10a that is open toward the one side in the axial direction, and the stator core 10 is arranged inside the coil 9. The armature 11 is made of a magnetic material (e.g., ferromagnetic material such as iron), and is arranged so as to be opposed to the stator core 10 in the axial direction. The armature 11 is fixed to the rod 3.

The yoke 12 is made of a magnetic material (e.g., ferromagnetic material such as Iron). The yoke 12 includes a wall portion 12a that covers an outer periphery of the coil 9, and an extension portion 12b that extends radially inward from an end of the wall portion 12a to cover an end surface of the coil 9 on the one side in the axial direction. The yoke 12 has a cylindrical shape covering the coil 9 from radially outside.

The spring 7 is a compression coil spring, and urges the armature 11 fixed to the rod 3 in a valve closing direction, i.e., toward the one side in the axial direction. In other words, the spring 7 provides an urging force on the valve body via the rod 3 in the valve closing direction. The spring 7 is accommodated in the spring housing hole 10a.

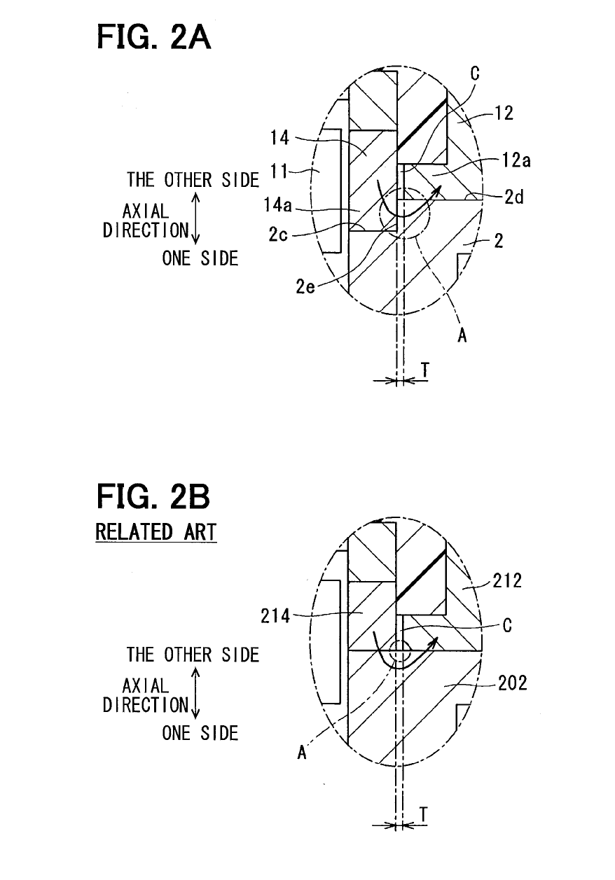

The housing 2 accommodates the armature 11 and the rod 3 therein, and is made of a non-magnetic material such as hardened steel (e.g., chromium molybdenum steel (SCM415)). The housing 2 is arranged on the one side in the axial direction with reference to the yoke 12, and is fixed to the yoke 12 by welding for example, so as to serve as a magnetic path. The housing 2 includes a slide hole 2a that is open toward the other side in the axial direction and supports the armature 11 slidably, and a large hole 2b that is provided on the other side in the axial direction with reference to the slide hole 2a to communicate with the slide hole 2a. The large hole 2b is larger than the slide hole 2a in a radial direction of the coil 9. The slide hole 2a and the large hole 2b are coaxial with each other, and a step portion 2c is provided between the slide hole 2a and the large hole 2b because of the size difference in the radial direction between the slide hole 2a and the large hole 2b. The step portion 2c has a surface facing toward the other side in the axial direction. The housing 2 may be formed in a cylindrical shape. As shown in FIG. 2A, the housing 2 may have a first contact surface 2d that axially contacts the yoke 12, and the first contact surface 2d may be located on the one side in the axial direction with reference to the coil 9.

The decompression valve 1 further includes a ring-shaped magnetic plate 14 that has an axially one-side portion 14a located in a part of the magnetic plate 14 on the one side in the axial direction. The axially one-side portion 14a is inserted into the large hole 2b to be fixed to the housing 2. The magnetic plate 14 is made of a magnetic material (e.g., ferromagnetic material such as iron). An inner peripheral surface of the magnetic plate 14 faces an outer peripheral surface of the armature 11 on the other side in the axial direction with reference to the large hole 2b, and an outer peripheral surface the magnetic plate 14 faces to the extension portion 12b in the radial direction via a clearance C on the other side in the axial direction with reference to the large hole 2b. The axially one-side portion 14a of the magnetic plate 14 radially contacts the housing 2 on the one side in the axial direction with reference to a position where the yoke 12 contacts the housing 2, and on a radially outer side of an inner peripheral surface of the slide hole 2a. The magnetic plate 14 may be located on a radially inner side of the yoke 12 and the housing 2. As shown in FIG. 2A, the housing 2 may have a second contact surface 2e that radially contacts the magnetic plate 14 on a radially inner side of the housing 2. An end of the second contact surface 2e on the other side in the axial direction may be connected radially and linearly to the first contact surface 2d. The end of the second contact surface 2e on the other side in the axial direction may be located the clearance C away from a radially inner end of the first contact surface 2d. The first contact surface 2d may be parallel to the axial direction, and the second contact surface 2e may be perpendicular to the axial direction. The yoke 12 may contact the housing 2 on an entire circumference, and the magnetic plate 14 may contact the housing 2 on an entire circumference.

The magnetic plate 14 is press-fitted into the large hole 2b to contact the step portion 2c, and the axially one-side portion 14a is joined to an inner peripheral surface of the large hole 2b by welding, so that the magnetic plate 14 is fixed to the housing 2. The magnetic plate 14 is fixed to the stator core 10 via a non-magnetic collar 16 by welding or the like. The decompression valve 1 includes a subassembly referred to as a first assembly 21. The first assembly 21 includes the stator core 10, the collar 16, the magnetic plate 14 and the housing 2 which are integrated with each other by welding.

The decompression valve 1 further includes another subassembly referred to as a second assembly 22. The second assembly 22 includes the coil 9 and the yoke 12. The decompression valve 1 is assembled such that; (i) the first assembly 21 is combined with the second assembly 22 so that the stator core 10 is inserted into the coil 9; (ii) the connector 9b is located at a predetermined position with respect to the first assembly 21 by rotating the second assembly 22; and (iii) the first assembly 21 and the second assembly 22 are fixed by using a nut 23.

The clearance C is provided for making the second assembly 22 be rotatable with respect to the first assembly 21 when the first assembly 21 is combined with the second assembly 22. The nut 23 is fixed to the stator core 10 so that the second assembly 22 is fixed between the nut 23 and the housing 2, and the nut 23 contacts the stator core 10 and the yoke 12 to serve as a magnetic path. Upon energization of the coil 9, a closed magnetic circuit is formed, passing through the stator core 10, the armature 11, the magnetic plate 14, the housing 2, the yoke 12 and the nut 23. Effects of the exemplar embodiment will be described. The axially one-side portion 14a of the magnetic plate 14 radially contacts the housing 2 on the radially outer side of the inner peripheral surface of the slide hole 2a in the closed magnetic circuit passing through the stator core 10, the armature 11, the magnetic plate 14, the housing 2, the yoke 12 and the nut 23. In a comparative example, as shown in FIG. 2B, a yoke 212 and a magnetic plate 214 contact a surface of a housing 202 in the axial direction on the other side in the axial direction with reference to the housing 202. In the present embodiment, as shown in FIG. 2A, the magnetic plate 14 extends toward the one side in the axial direction to contact the housing 2 in both the axial direction and the radial direction.

Accordingly, in the present embodiment, a distance traveled by a magnetic flux in the housing 2 can be shortened as compared with the comparative example. In the comparative example, because the yoke 212 and the magnetic plate 214 contact the surface of the housing 202 on the other side only in the axial direction, the magnetic flux passes through the housing 202 from the magnetic plate 214 to the yoke 212 by U-turning in the housing 202 as shown by an arrow in FIG. 2B. Specifically, the magnetic flux flows toward the one side in the axial direction to enter into the housing 202 from the magnetic plate 214, and then U-turns in the housing 202 and flows toward the other side in the axial direction to enter into the yoke 212. In the present embodiment, as shown in FIG. 2A, a magnetic flux is capable of entering from the magnetic plate 14 through the housing 2 into the yoke 12 smoothly. Specifically, the magnetic flux flows from the magnetic plate 14 outward in the radial direction into the housing 2, and then enters into the yoke 12 without U-turning in the housing 2.

Because the housings 2 and 202 are made of the non-magnetic material, the housings 2 and 202 have a large magnetic resistance and a relatively-low magnetic flux density. Thus, in the comparative example, a magnetic flux density between the magnetic plate 214 and the yoke 212 may decrease, and a region A, in which the magnetic flux density is relatively high, may be thereby small as shown in FIG. 2B. In contrast, in the present embodiment, the distance traveled by the magnetic flux in the housing 2 can be shortened. Therefore, the region A, in which the magnetic flux density is relatively high, is larger in the present embodiment than in the comparative example.

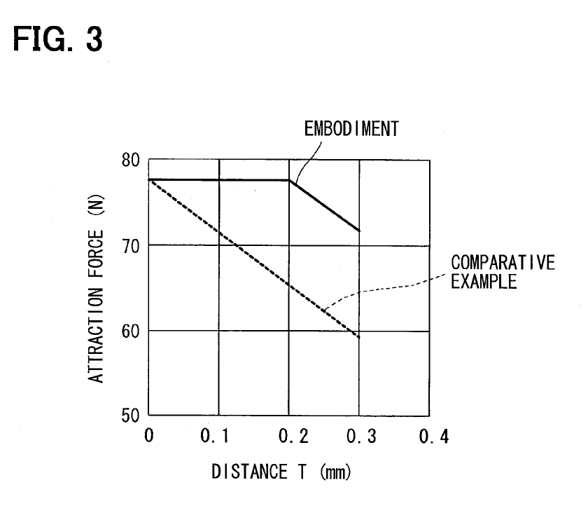

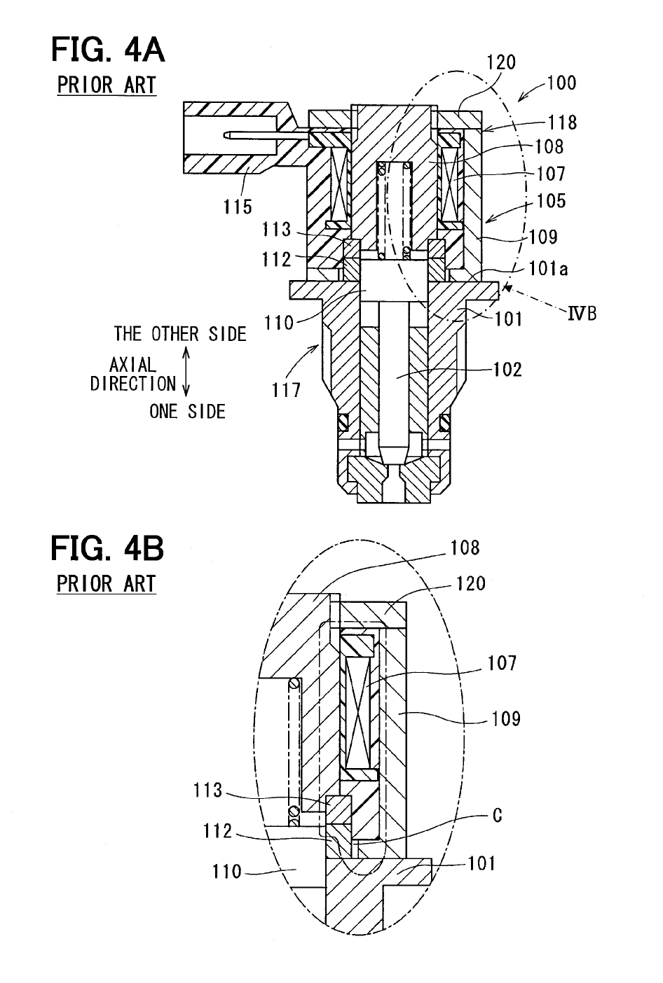

Accordingly, a magnetic attraction force can be maintained high in the present embodiment. As shown in FIG. 3, while the magnetic attraction force decreases linearly in accordance with increase of a distance T of the clearance C in the comparative example, the magnetic attraction force does not decrease in accordance with the increase of the distance T of the clearance C until the distance T reaches a predetermined value in the present embodiment. The magnetic attraction force can be kept higher in the present example than in the comparative example at the same distance T of the clearance C. Hence, in the present embodiment, even when the housing 2 is made of a non-magnetic material, the magnetic flux density can be kept high. Therefore, decrease of the magnetic attraction force can be limited, with keeping the housing 2 high in mechanical strength.

Although the present disclosure has been fully described in connection with the exemplar embodiment thereof with reference to the accompanying drawings, it is to be noted that various changes and modifications will become apparent to those skilled in the art.

In the exemplar embodiment, the magnetic plate 14 is fixed to the housing 2 by press-fitting the magnetic plate 14 into the large hole 2b so that the magnetic plate 14 contact the step portion 2c, and by welding between the magnetic plate 14 and the housing 2. However, the magnetic plate 14 may be fixed to the housing 2 only by the press-fitting. Additionally, the magnetic plate 14 may be fixed to the housing 2 by one of fixing methods: welding, crimping and brazing. The magnetic plate 14 may be fixed to the housing 2 by adopting one of the fixing methods: welding, crimping and brazing, in addition to the press-fitting. The magnetic plate 14 may be separated from the step portion 2c.

The slide hole 2a may support the armature 11 by supporting the rod 3 slidably.

In the exemplar embodiment, the present disclosure is applied to the decompression valve 1, but application of the present disclosure is not limited to the decompression valve 1. The present disclosure can be applied to a variety of electromagnetic valves.

Additional advantages and modifications will readily occur to those skilled in the art. The disclosure in its broader terms is therefore not limited to the specific details, representative apparatus, and illustrative examples shown and described.

What is claimed is:

1. An electromagnetic valve comprising:
a coil that generates a magnetic force when being energized;
a stator core arranged on a radially inner side of the coil to serve as a magnetic path;
an armature arranged on one side in an axial direction of the coil with reference to the stator core to be movable toward the stator core by the magnetic force;
a yoke arranged on a radially outer side of the coil to serve as a magnetic path;
a housing arranged on the one side in the axial direction with reference to the yoke to serve as a magnetic path and to axially contact the yoke, the housing including a slide hole supporting the armature slidably; and
a ring-shaped magnetic plate facing to an outer peripheral surface of the armature on a radially inner side of the magnetic plate, and facing to the yoke via a clearance on a radially outer side of the magnetic plate, wherein the magnetic plate radially contacts the housing on the one side in the axial direction with reference to a position where the yoke contacts the housing, and on a radially outer side of an inner surface of the slide hole.

2. The electromagnetic valve according to claim 1, wherein
the housing includes a large hole provided on the other side in the axial direction with reference to the slide hole to communicate with the slide hole,
a radial dimension of the large hole is larger than a radial dimension of the slide hole,
the magnetic plate includes an axially one-side portion on the one side in the axial direction, and
the axially one-side portion is inserted into the large hole to be fixed to the housing.

3. The electromagnetic valve according to claim 2, wherein
the large hole and the slide hole are arranged to provide a step portion between the large hole and the slide hole, and
the magnetic plate has a surface contacting the step portion on the one side in the axial direction with reference to the magnetic plate.

4. The electromagnetic valve according to claim 2, wherein the magnetic plate is press-fitted into the large hole.

5. The electromagnetic valve according to claim 2, wherein the magnetic plate is fixed to the housing by welding in the large hole.

6. The electromagnetic valve according to claim 2, wherein the magnetic plate is fixed to the housing by crimping in a state where the magnetic plate is inserted into the large hole.

7. The electromagnetic valve according to claim 2, wherein the magnetic plate is fixed to the housing by brazing in the large hole.

8. An electromagnetic valve comprising:
a coil that generates a magnetic force when being energized;
a stator core arranged on a radially inner side of the coil;
an armature arranged on one side in an axial direction of the coil with reference to the stator core to be movable toward the stator core by the magnetic force;
a yoke arranged on a radially outer side of the coil, the yoke having a cylindrical shape covering the coil from radially outside;
a cylindrical housing arranged on the one side in the axial direction with reference to the yoke, the housing having a first contact surface that axially contacts the yoke, the first contact surface being located on the one side in the axial direction with reference to the coil; and
a ring-shaped magnetic plate located on a radially inner side of the yoke and the housing, the magnetic plate facing to the armature on a radially inner side of the magnetic plate, and facing to the yoke via a clearance on a radially outer side of the magnetic plate, wherein
the housing further has a second contact surface that radially contacts the magnetic plate on a radially inner side of the housing.

9. The electromagnetic valve according to claim 8, wherein
an end of the second contact surface on the other side in the axial direction is connected radially and linearly to the first contact surface, and
the end of the second contact surface on the other side in the axial direction is located the clearance away from a radially inner end of the first contact surface.

10. The electromagnetic valve according to claim 8, wherein the first contact surface is parallel to the axial direction, and the second contact surface is perpendicular to the axial direction.

11. The electromagnetic valve according to claim 8, wherein the yoke contacts the housing on an entire circumference, and the magnetic plate contacts the housing on an entire circumference.
